(19) United States
(12) Patent Application Publication
(10) Pub. No.: US 2019/0078609 A1
(43) Pub. Date: Mar. 14, 2019

(54) SHAFT

(71) Applicant: AISIN AW CO., LTD., Anjo-shi, Aichi-ken (JP)

(72) Inventors: Atsushi MORI, Anjo (JP); Katsuhiro MAENO, Anjo (JP); Naoki TAKABAYASHI, Nishio (JP); Akihiko KITA, Anjo (JP); Kiyoshi TAJIMA, Nishio (JP); Toshiya IINUMA, Anjo (JP); Kyohei IWATA, Inazawa (JP)

(73) Assignee: AISIN AW CO., LTD., Anjo-shi, Aichi-ken (JP)

(21) Appl. No.: 16/080,859

(22) PCT Filed: Mar. 17, 2017
(86) PCT No.: PCT/JP2017/010874

§ 371 Date: Aug. 29, 2018

(30) Foreign Application Priority Data
Mar. 30, 2016 (JP) 2016-068066

(51) Int. Cl. F16C 3/02; F16H 57/04

(52) U.S. Cl. CPC F16C 3/02; F16H 2061/0046; F16H 57/043

(57) ABSTRACT

A shaft has a hole that extends radially outward from an inner portion and opens in an outer peripheral surface. An opening of the hole has an outer shape which has a first curvature and a second curvature that is smaller than the first curvature when viewed in a radial direction of the shaft. The hole has, in the radial direction of the shaft, an outer hole portion that extends radially inward from an open end while maintaining the outer shape, a tubular inner hole portion that has a smaller hole diameter than the outer hole portion, and a diameter reduction portion in which the diameter is reduced from the outer hole portion towards the inner hole portion. The outer hole portion, the diameter reduction portion, and the inner hole portion are formed so as to be arranged in this order from the radially outer side.

### TECHNICAL FIELD

The following disclosure relates to a shaft.

### BACKGROUND ART

Conventionally, a shaft which is used in an automatic transmission and which has a lubrication hole that extends radially from an inner portion and opens in an outer peripheral surface is proposed as this type of shaft (for example, see Patent Document 1). The shaft has the elongated lubrication hole extending along a direction offset 45 degrees from an axial direction of the shaft. The lubrication hole is generally circular on an inner radial side in a radial direction of the shaft and is formed by a taper (chamfered shape), such that, as it extends from the inner radial side, the hole gradually elongates in the direction of the outer radial side. Thus, stress concentration caused by the torsion of the shaft that occurs with the transmission of torque can be reduced and durability can be improved.

### RELATED ART DOCUMENT

### Patent Document

Patent Document 1: U.S. Pat. No. 8,187,133

### SUMMARY

The conventional shaft is acknowledged to be effective in reducing concentration of stress caused by the torsion of the shaft compared to a circular lubrication hole. However, depending on the chamfered shape of the hole, the concentration of stress may not be sufficiently reduced, and thus the shaft should be further improved.

An object of certain aspects of some preferred embodiments of the disclosure is to further increase the strength against torsion caused by the shaft which has a hole that extends radially outward from an inner portion and that opens in an outer peripheral surface.

Preferred embodiments of the disclosure took the following means to achieve the main object described above.

A shaft of the disclosure is a shaft that is rotated by external force, including: a hole that extends radially outward from an inner portion and opens in an outer peripheral surface, wherein an opening of the hole has an outer shape which has a first curvature and a second curvature that is smaller than the first curvature when viewed in a radial direction of the shaft, and the hole has, in the radial direction of the shaft, an outer hole portion that extends radially inward from an open end for a prescribed length while maintaining the outer shape, a tubular inner hole portion that has a smaller hole diameter than the outer hole portion, and a diameter reduction portion in which the diameter is reduced from the outer hole portion towards the inner hole portion, the outer hole portion, the diameter reduction portion, and the inner hole portion formed so as to be arranged in this order from a radially outer side towards an inner side of the shaft.

In the shaft of the disclosure which has the hole extending radially outward from the inner portion and opening in the outer peripheral surface, the opening of the hole has the outer shape that has the first curvature and the second curvature which is smaller than the first curvature when viewed in the radial direction of the shaft. The hole has, in the radial direction of the shaft, the outer hole portion that extends radially inward from the open end for the prescribed length while maintaining the outer shape, the tubular inner hole portion that has a smaller hole diameter than the outer hole portion, and the diameter reduction portion in which the diameter is reduced from the outer hole portion towards the inner hole portion. The outer hole portion, the diameter reduction portion, and the inner hole portion are formed so as to be arranged in this order from the radially outer side towards the inner side of the shaft. Thus, if the surface, in the inner peripheral surface of the opening portion (outer hole portion) of the hole, on which the tensile stress acts when force is applied in the torsion direction of the shaft, is formed by the surface having the second curvature that is smaller than the first curvature, it is possible to disperse the tensile stress by the surface having the second curvature to avoid concentration of stress. Additionally, it is possible to avoid concentration of stress between the opening portion (outer hole portion) and the inner hole portion by smoothly connecting the opening portion (outer hole portion) and the inner hole portion with the diameter reduction portion (curved surface). As a result, the strength of the shaft against torsion can be increased. Here, the second curvature includes zero curvature, that is, the flat surface (straight line) other than the curved surface (curved line).

### BRIEF DESCRIPTION OF THE DRAWINGS

FIG. 1 is an external view of a shaft 20 according to the embodiment.

FIG. 2 is a sectional view of the shaft 20 taken along line A-A in FIG. 1.

FIG. 3 is a partially enlarged view of a region B of the shaft 20 in FIG. 1.

FIG. 4 is a sectional view of the shaft 20 taken along line C-C in FIG. 1.

FIG. 5 is an explanatory view of the shape of an opening portion 241 and a diameter expansion portion 243 of an oil hole 24.

FIG. 6A is an explanatory view of an example of a forming step of the oil hole 24.

FIG. 6B is an explanatory view of the example of the forming step of the oil hole 24.

FIG. 6C is an explanatory view of the example of the forming step of the oil hole 24.

FIG. 6D is an explanatory view of the example of the forming step of the oil hole 24.

FIG. 7A is an explanatory view of rotary torque being input to the shaft 20.

FIG. 7B is an explanatory view of rotary torque being input to the shaft 20.

FIG. 8A is a graph of distribution of von Mises stress in which a plane inclined 45 degrees to an axis of the oil hole of the shaft in the embodiment is a plane of action.

FIG. 8B is a graph of distribution of von Mises stress in which a plane inclined 45 degrees to the axis of the oil hole of the shaft in a comparative example is the plane of action.

FIG. 9 is an explanatory view of a shaft 20B according to another embodiment.

### BEST MODES

Modes for carrying out various preferred embodiments of the disclosure will be described below with reference to the drawings. The Cr and (I) etc. in the figures and the text are used as symbols and do not represent the actual curvature and radius etc.

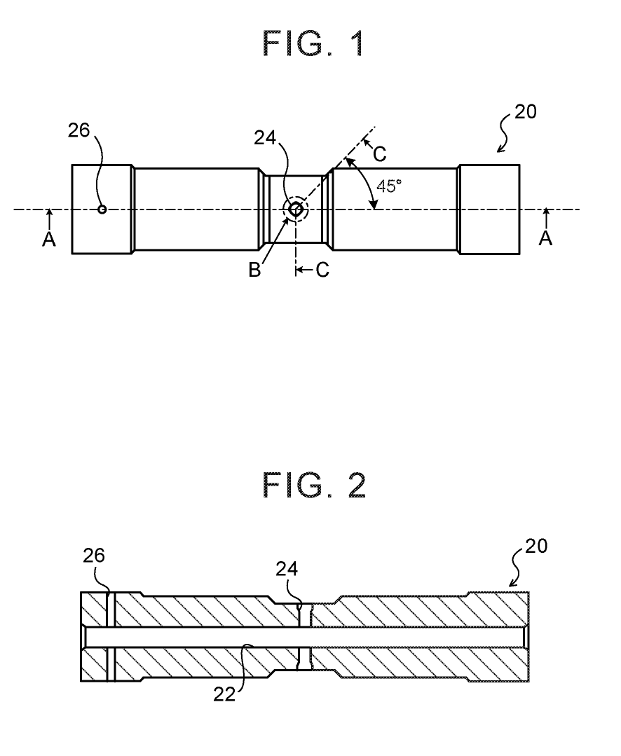

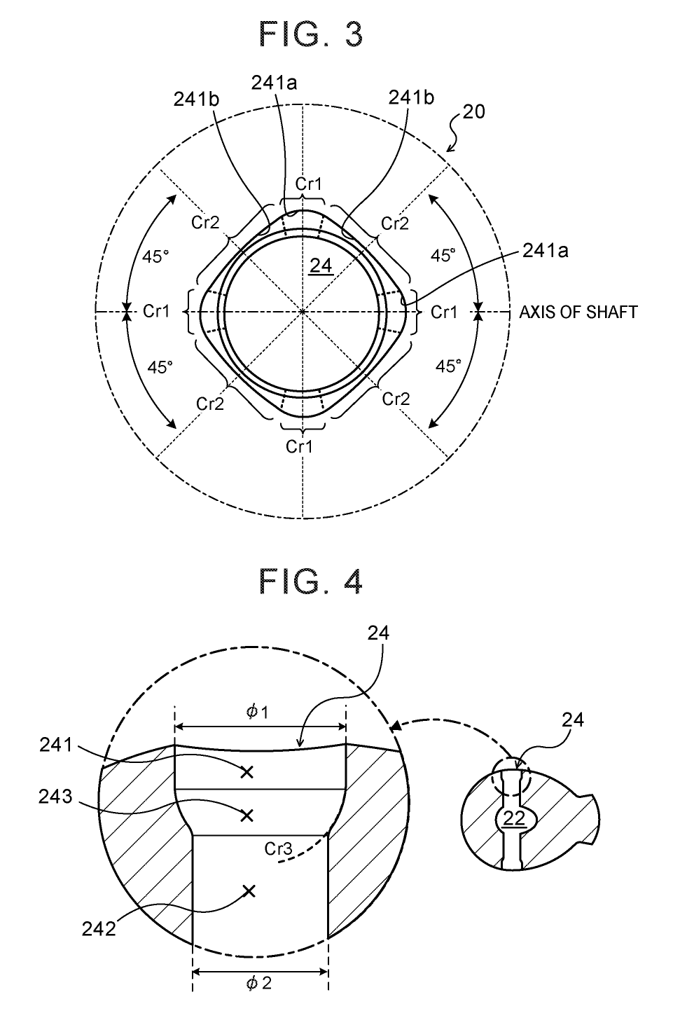

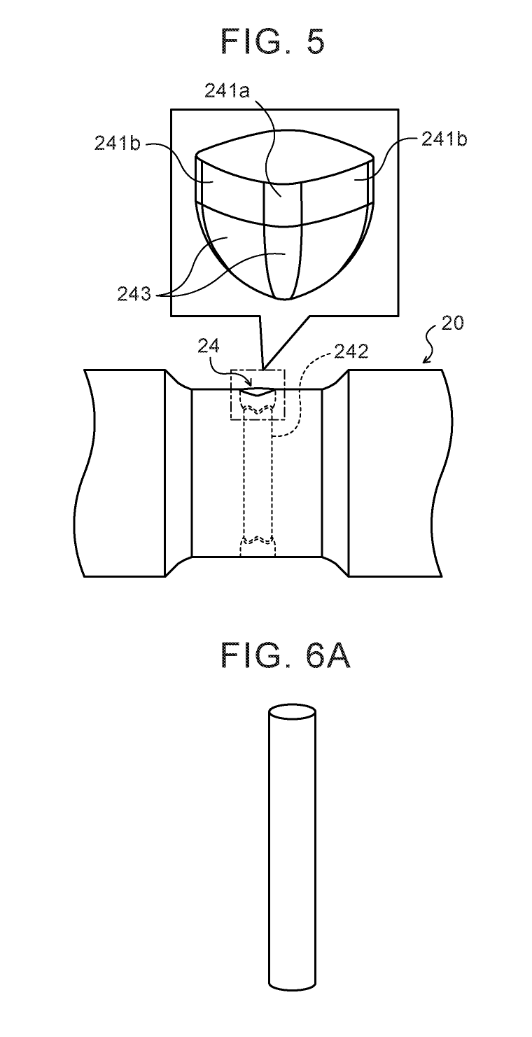

FIG. 1 is an external view of a shaft 20 according to an embodiment. FIG. 2 is a sectional view of the shaft 20 taken along line A-A in FIG. 1. FIG. 3 is a partially enlarged view of a region B of the shaft 20 in FIG. 1. FIG. 4 is a sectional view of the shaft 20 taken along line C-C in FIG. 1. FIG. 5 is an explanatory view of the shape of an opening portion 241 and a diameter expansion portion 243 of an oil hole 24.

The shaft 20 of the embodiment is used as a shaft for a transmission for shifting the power from a power source such as an engine or a motor installed in a vehicle and transmitting the power to an axle coupled to driving wheels, for example. Examples of the shaft for a transmission include an input shaft to which power is input from the power source, various shafts to which power from the input shaft is transmitted (an intermediate shaft etc.), and a pinion shaft which is supported by a planetary carrier of a planetary gear provided in the transmission.

The shaft 20 is a steel shaft, in which an oil passage 22 that extends in the axial direction and oil holes 24, 26 that extend radially outward from the oil passage 22 and open in the outer peripheral surface are formed. The shaft 20 introduces working oil for lubrication and cooling from the oil hole 26, and discharges working oil from the oil hole 24 through the oil passage 22.

The opening portion (outer hole portion) 241 of the oil hole 24 has a non-circular inner peripheral surface with different curvatures in the circumferential direction as shown in FIG. 3. Thus, the inner peripheral surface of the opening portion 241 has a first curved surface 241a having a first curvature Cr1 in the four places in the axial direction and a direction orthogonal to the axis. The inner peripheral surface also has a second curved surface 241b having a second curvature Cr2 that is smaller than the first curvature Cr1 in the four places in directions at an angle of 45 degrees to the axis of the shaft 20. The first curved surface 241a and the second curved surface 241b that are adjacent to each other in the circumferential direction are smoothly connected. That is, in order to set the dimensions so that shearing stress which occurs in the first curved surface 241a is equivalent in magnitude to compression stress and tensile stress which occur in the second curved surface 241b, the inner peripheral surface of the opening portion 241 is formed by smoothly connecting the second curved surface 241b and the second curved surface 241b that are adjacent to each other with the first curved surface 241a while ensuring the maximum length of an arc portion of the second curved surface 241b.

An inner portion 242 of the oil hole 24 (inner hole portion) has a circular inner peripheral surface of which an inner diameter is smaller than the inner diameter (inner diameter of a short side) of the opening portion 241 (outer hole portion). Between the opening portion 241 and the inner portion 242, the diameter expansion portion 243 is formed, in which the diameter is expanded in an arc-shape with a third curvature Cr3 from the opening portion 241 towards the inner portion 242 (diameter reduction portion in which the diameter is reduced in an arc-shape in the direction from the opening portion 241 towards the inner portion 242), as shown in FIG. 4. The opening portion 241 and the inner portion 242 are smoothly connected with the diameter expansion portion 243. As shown in FIG. 4, the diameter expansion portion 243 is formed of a concave surface that curves in a concave shape so that the rate of change of the diameter expansion decreases gradually from the inner peripheral surface of the inner portion 242 towards the inner peripheral surface of the opening portion 241. Thus, it is possible to prevent stress from concentrating in the diameter expansion portion 243. In this case, the shape of a boundary between the diameter expansion portion 243 and the inner portion 242 is discontinuous, and thus, in order to avoid concentration of stress in the portion, a round surface (R) that smoothly connects the diameter expansion portion 243 to the inner portion 242 is provided.

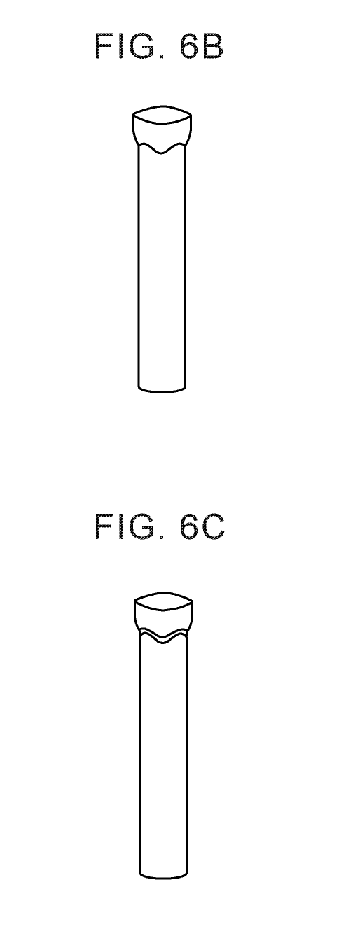

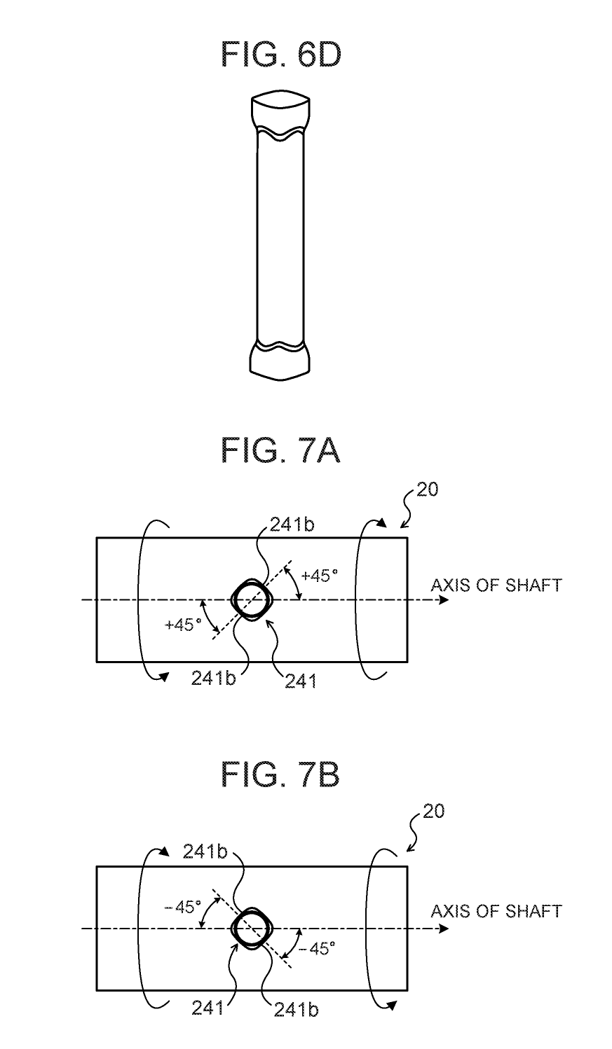

FIG. 6A, FIG. 6B, FIG. 6C, and FIG. 6D are explanatory views of an example of a forming step of the oil holes 24. The formation of each oil hole 24 is performed as follows. First, drilling is performed, in which a hole is formed so as to pass through the shaft 20 in the radial direction intersecting the axis of the shaft 20 with a drill etc. (see FIG. 6A). Then, counterboring is performed, in which the opening area of the hole formed by drilling is expanded by pressing or cutting etc. to form the opening portion 241 and the diameter expansion portion 243 (see FIG. 6B). Since the diameter expansion portion 243 has a concave surface as described above, it is possible to easily form the diameter expansion portion 243 due to pressing etc. Additionally, a portion of the diameter expansion portion 243, in which the rate of change of diameter expansion is the largest, becomes a boundary between the inner portion 242 and the diameter expansion portion 243. The boundary has an undulating shape between the inner peripheral surface of the diameter expansion portion 243 and the inner peripheral surface of the inner portion 242. Thus, it is possible to easily perform rounding afterward. Then, rounding is performed, in which a smooth rounded surface (R) is provided by pressing or cutting the boundary between the formed diameter expansion portion 243 and the inner portion 242 (see FIG. 6C). Then, the boring and rounding described above are performed on the other side of the hole (see FIG. 6D), and thus, the forming step is finished. When all of the oil passage 22 and the oil hole 26, including the oil hole 24, are formed in the shaft 20, the shaft 20 is heat-treated and the outer peripheral surface is polished afterwards. In this way, the formation of the oil hole 24 is executed before heat-treatment, that is, before the shaft 20 is cured. The boring and the rounding described above can thus be executed easily and with high accuracy.

A case in which a rotary torque is applied to the shaft 20 will be discussed. In this case, shearing stress is applied along the cross section and the longitudinal section of the oil hole 24 with respect to the axis of the shaft 20. In the opening portion of the oil hole, tensile stress and compression stress occur on a plane inclined 45 degrees to a plane on which shearing stress occurs, and the values of compression stress and tensile stress are both equal to the value of shearing stress in the shaft radius. Compression stress acts on a plane inclined 90 degrees to a plane on which the largest tensile stress acts. In the inner peripheral surface of the hole 24 of the shaft 20 according to the embodiment, a surface on which shearing stress acts when rotary torque is applied is formed of the first curved surface 241a with the relatively large first curvature Cr1, and a surface on which compression stress or tensile stress acts when the rotary torque applied is formed of the second curved surface 241b with the relatively small second curvature Cr2. Thus, the strength of the shaft 20 against torsion can be improved, since tensile stress that acts on the inner peripheral surface of the oil hole 24 can be dispersed by the second curved surface 241b with respect to the torsion of the shaft 20.

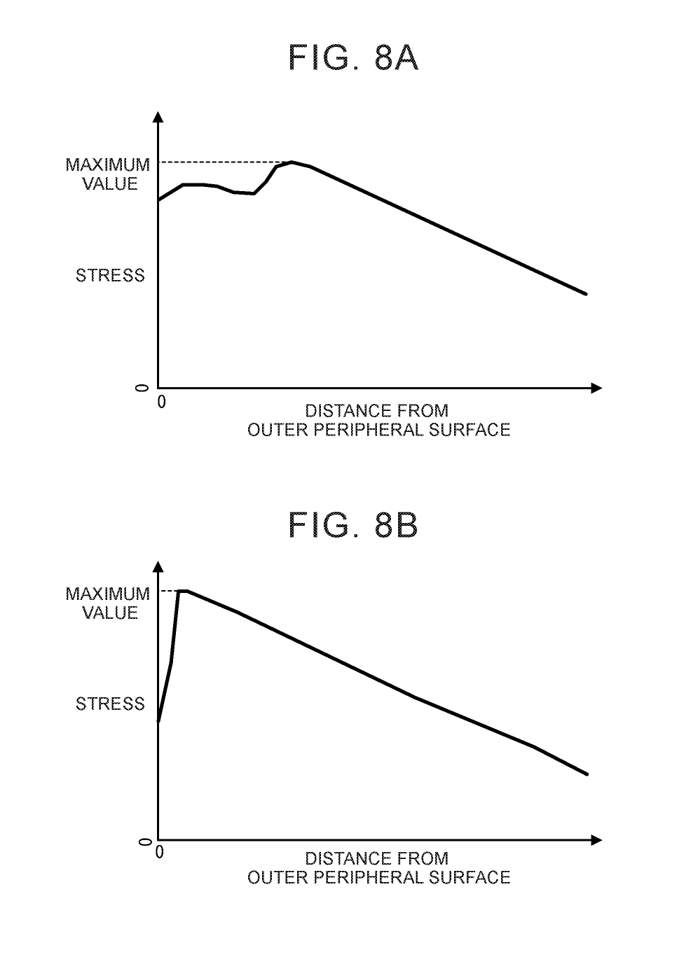

FIG. 8 is a graph showing distribution of von Mises stress when a plane inclined 45 degrees to the axis of the oil hole of the shaft serves as a plane of action. FIG. 8A shows the distribution in the oil hole 24 of the embodiment. FIG. 8B shows the distribution in an oil hole of a comparative example. In the comparative example, the opening portion of the oil hole is chamfered (tapered surface is provided), in which the chamfering angle is 45 degrees and the curvature is constant in the circumferential direction (circular shape). In the example of FIG. 8, a split shaft that extends perpendicularly to the extending direction of the oil hole and that is split by a plane that includes the axis of the shaft is used, and an end of the split shaft is fixed while rotary torque of 500 Nm is applied to the other end in either the forward or reverse directions. A simulation was performed by measuring the stress generated in the plane of action of the oil hole for every distance towards the inner radial side from the shaft surface (outer peripheral surface). As shown in the drawing, when the maximum value of the von Mises stress in the plane of action of the oil hole 24 in the embodiment is σ1 and the maximum value of the von Mises stress in the plane of action of the oil hole in the comparative example is σ2, the value of σ1 is smaller than the value of σ2. In this way, it has been confirmed that stress caused by torsion is appropriately dispersed and a high strength is ensured in the shaft 20 which has the oil hole 24 of the embodiment, compared to the shaft which has the oil hole of the comparative example. Especially, in the oil hole of the shaft of the comparative example, the portion in which the von Mises stress has the maximum value σ2 is the root portion of the chamfer, and a high strength against torsion of the shaft 20 can be obtained by replacing the chamfer (tapered surface) with the diameter expansion portion 243 (curved surface).

Here, a vehicle is considered, in which the engine connected to the input shaft of the automatic transmission via the clutch and the motor connected to the input shaft are provided, and the shaft 20 is configured as the input shaft or the intermediate shaft, for example. In the vehicle, the torsion direction of the shaft 20 when driving torque is output from the engine or the motor while the vehicle is being driven (during acceleration) is opposite to that when braking torque (regenerative torque) is output from the motor while the braking is applied to the vehicle (during deceleration). In the shaft 20 of the embodiment, the opening portion 241 of the oil hole 24 has, as shown in FIGS. 7A, 7B, the second curved surface 241b having the second curvature Cr2 that is smaller than the first curvature Cr1, at a 45 degree offset in the direction in which the shaft 20 twists due to the driving torque, with respect to the axial direction of the shaft (in FIG. 7A, +45 degrees) and at a 45 degree offset in the direction in which the shaft 20 twists due to the braking torque (in FIG. 7B, −45 degrees). Thus, when a relatively large driving torque is output from the engine or motor while the vehicle is being driven, a high strength (durability) against the torsion of the shaft 20 caused by the driving torque can be ensured. Additionally, when a relatively large braking torque (regenerative torque) is output from the motor while braking is applied to the vehicle, a high strength (durability) can be ensured against the torsion of the shaft 20 caused by the braking torque.

In the shaft 20 of the embodiment described above, a non-circular inner peripheral surface varying in curvatures in the circumferential direction is formed in the opening portion 241 of the oil hole 24 that extends radially outward from the inner portion. In the inner peripheral surface of the opening portion 241, the surfaces set in the axial direction of the shaft 20 and the surfaces set in the direction orthogonal to the axis of the shaft 20, that is, the surfaces on which shearing stress acts when rotary torque is applied, are each formed by the first curved surface 241a with the relatively large first curvature Cr1, and the surfaces set at 45 degrees to the axis of the shaft 20, that is, the surfaces on which compression stress or tensile stress acts when rotary torque is applied, are each formed by the second curved surface 241b having the second curvature Cr2 that is smaller than the first curvature Cr1. Thus, it is possible to effectively disperse tensile stress acting on the inner peripheral surface of the opening portion 241 of the oil hole 24 with the torsion of the shaft 20 and increase the strength of the shaft 20. The opening portion (outer hole portion) 241 and the inner portion (inner hole portion) 242 can be smoothly connected with the diameter expansion portion 243 (diameter reduction portion). Thus, it is possible to avoid concentration of stress between the opening portion 241 and the inner portion 242 and increase the strength of the shaft 20. Therefore, compared to the conventional shaft, in which a circular chamfer is provided in the opening portion of the oil hole, the shaft 20 of the embodiment can cope with a larger rotary torque transmission. If the magnitude of the rotary torque is the same, the outer diameter of the shaft 20 can be made smaller than that of the conventional shaft.

In the embodiment described above, the inner peripheral surface (first curved surface 241a, second curved surface 241b) having two different curvatures (first curvature Cr1, second curvature Cr2) is formed in the opening portion 241 of the oil hole 24. However, an inner peripheral surface having three or more curvatures may also be formed. For example, presume the shaft is used as a shaft for a transmission that shifts power from the engine or the motor to transmit the power to the axle, and the curvatures are regarded as curvature A, curvature B, curvature C in order from smallest to largest. In this case, in the inner surface of the oil hole, it is possible to form with a curved surface (or flat surface) having the curvature A, a surface at a 45 degree offset (at +45°) in the direction in which the shaft 20 twists due to the driving torque (engine torque or motor torque), with respect to the axial direction of the shaft, form with a curved surface having the curvature B, a surface at a 45 degree offset (at −45°) in the direction in which the shaft 20 twists due to the braking torque (engine braking or motor regenerative torque), with respect to the axial direction of the shaft and smoothly connect the curved surface having the curvature A and the curved surface having the curvature B with the curved surface having the curvature C.

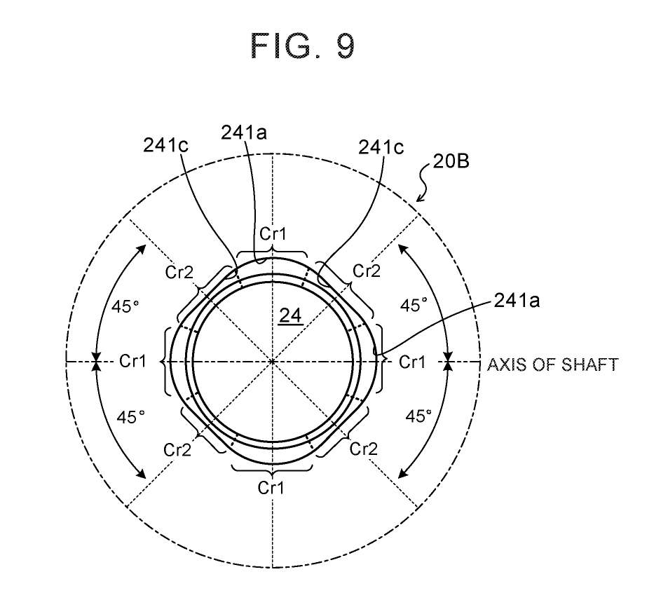

In the embodiment described above, the surface in the direction inclined 45 degrees to the axis of the shaft 20 is formed by the second curved surface 241b having the second curvature Cr2 that is smaller than the first curvature Cr1. However, as shown by a shaft 20B of another embodiment in FIG. 9, the surface may be formed by a surface having zero curvature as the second curvature Cr2, that is, a flat surface 241c. In this case, the first curved surface 241a may be formed so that it smoothly connects with the flat surface 241c in the circumferential direction.

In the embodiment described above, regions that include all of the directions inclined 45 degrees to the axis of the shaft 20 (four places in FIG. 3) are formed by the second curved surfaces 241b or the flat surfaces 241c. However, two places, namely, a first region including the direction inclined 45 degrees to the axis of the shaft 20 and a region including the direction inclined 45 degrees that faces the first region (only either the regions in FIG. 7A or the regions in FIG. 7B), may be formed by the second curved surface 241b or the flat surface 241c.

In the embodiment described above, the diameter expansion portion 243 is formed by the concave surface that curves in a concave shape so that the rate of change of the diameter expansion decreases gradually from the inner peripheral surface of the inner portion 242 towards the inner peripheral surface of the opening portion 241. However, the diameter expansion portion 243 is not limited to this, and may be formed by a convex surface that curves in a convex shape so that the rate of change of the diameter expansion increases gradually from the inner peripheral surface of the inner portion 242 towards the inner peripheral surface of the opening portion 241. This also makes it possible to avoid concentration of stress in the diameter expansion portion. In this case, the shape of the boundary between the diameter expansion portion and the opening portion 241 is discontinuous. Thus, a round surface (R) that smoothly connects may be provided in order to avoid concentration of stress in the portion.

As described above, the shaft of the disclosure is the shaft (20) that is rotated by an external force, and has the hole (24) that extends radially outward from the inner portion and opens in the outer peripheral surface. The opening of the hole (24) has an outer shape which has the first curvature (Crl) and the second curvature (Cr2) that is smaller than the first curvature (Cr1), when viewed in the radial direction of the shaft. The hole has, in the radial direction of the shaft, the outer hole portion (241) that extends radially inward from an open end for a prescribed length while maintaining the outer shape, the tubular inner hole portion (242) that has a smaller hole diameter than the outer hole portion, and the diameter reduction portion (243) in which the diameter is reduced from the outer hole portion (241) towards the inner hole portion (242). The outer hole portion (241), the diameter reduction portion (243), and the inner hole portion (242) are formed so as to be arranged in this order from the radially outer side of the shaft (20) towards the inner side of the shaft (20).

In the shaft of the disclosure which has the hole extending radially outward from the inner portion and opening in the outer peripheral surface, the opening of the hole has the outer shape that has the first curvature and the second curvature which is smaller than the first curvature when viewed in the radial direction of the shaft. The hole has, in the radial direction of the shaft, the outer hole portion that extends radially inward from the open end for the prescribed length while maintaining the outer shape, the tubular inner hole portion that has a smaller hole diameter than the outer hole portion, and the diameter reduction portion in which the diameter is reduced from the outer hole portion towards the inner hole portion. The outer hole portion, the diameter reduction portion, and the inner hole portion are formed so as to be arranged in this order from the radially outer side towards the inner side of the shaft. Thus, if the surface, in the inner peripheral surface of the opening portion (outer hole portion) of the hole, on which the tensile stress acts when force is applied in the torsion direction of the shaft, is formed of the surface having the second curvature that is smaller than the first curvature, it is possible to disperse the tensile stress by the surface having the second curvature to avoid concentration of stress. Additionally, it is possible to avoid concentration of stress between the opening portion (outer hole portion) and the inner hole portion by smoothly connecting the opening portion (outer hole portion) and the inner hole portion with the diameter reduction portion (curved surface). As a result, the strength of the shaft against torsion can be increased. Here, the second curvature includes zero curvature, that is, the flat surface (straight line) in addition to the curved surface (curved line).

In the shaft of the disclosure, the inner peripheral surface of the outer hole portion (241) may have the surface having the second curvature at a 45 degree offset in the direction in which the shaft (20) twists, with respect to the axial direction of the shaft (20), and may have the surface having the first curvature in the axial direction of the shaft (20). In this way, the surface in which the tensile stress against the torsion of the shaft becomes the largest is formed by the surface having the second curvature, and therefore the stress can be dispersed more certainly.

In the shaft of the disclosure, the inner peripheral surface of the outer hole portion (241) may have the surface having the second curvature at a +45 degree offset and a −45 degree offset, with respect to the axial direction of the shaft. In this way, even when the torsion of the shaft occurs in either the forward or reverse directions, stress can be dispersed more certainly.

In the shaft of the disclosure, the outer hole portion (241) may extend radially inward from the open end for the prescribed length, while being perpendicular to the axis of the shaft (20) and maintaining the outer shape. To be perpendicular to the axis of the shaft does not only mean to be perpendicular in the narrowest sense. An inclination to some extent is allowed, such as an inclination of a shear droop that occurs when the hole is formed by press punch processing or of a necessary draft.

In the shaft of the disclosure, the inner peripheral surface of the diameter reduction portion (243) may be formed by a concave surface that curves in a concave shape with respect to the extending direction of the hole. In this way, it is possible to suppress stress from being concentrated in a part with different diameters between the outer hole portion (opening portion) and the inner hole portion (inner portion) of the hole while maintaining the lubrication performance and the supplying performance of the oil in the inner portion of the hole at a similar level to a conventional oil hole, and further increase the strength of the shaft. The diameter reduction portion can be easily formed by press processing etc. since the inner peripheral surface of the diameter reduction portion is a concave surface.

The embodiments of the invention of the disclosure have been discussed above. However, the invention of the disclosure are not limited to the embodiments in any way, and it is a matter of course that the invention of the disclosure may be implemented in various modes without departing from the scope of the invention of the disclosure.

1-5. (canceled)

6. A shaft configured to be rotated by external force, comprising:
a hole that extends radially outward from an inner portion of the shaft and opens in an outer peripheral surface of the shaft, wherein
an opening of the hole has an outer shape which has a first curvature and a second curvature that is smaller than the first curvature when viewed in a radial direction of the shaft, and
the hole has, in the radial direction of the shaft, an outer hole portion that extends radially inward from an open end for a prescribed length while maintaining the outer shape, a tubular inner hole portion that has a smaller hole diameter than the outer hole portion, and a diameter reduction portion in which the diameter is reduced from the outer hole portion towards the inner hole portion, the outer hole portion, the diameter reduction portion, and the inner hole portion formed so as to be arranged in this order from a radially outer side towards an inner side of the shaft.

7. The shaft according to claim 6, wherein
an inner peripheral surface of the outer hole portion has a surface having the second curvature at a 45 degree offset in a direction in which the shaft twists, with respect to an axial direction of the shaft, and a surface having the first curvature in the axial direction of the shaft.

8. The shaft according to claim 7, wherein
the outer hole portion extends radially inward from the open end for a prescribed length, while being perpendicular to an axis of the shaft and maintaining the outer shape.

9. The shaft according to claim 8, wherein
an inner peripheral surface of the diameter reduction portion is formed by a concave surface that curves in a concave shape with respect to an extending direction of the hole.

10. The shaft according to claim 7, wherein
an inner peripheral surface of the diameter reduction portion is formed by a concave surface that curves in a concave shape with respect to an extending direction of the hole.

11. The shaft according to claim 6, wherein
the inner peripheral surface of the outer hole portion has the surface having the second curvature at a +45 degree offset and a −45 degree offset, with respect to the axial direction of the shaft.

12. The shaft according to claim 11, wherein
the outer hole portion extends radially inward from the open end for a prescribed length, while being perpendicular to an axis of the shaft and maintaining the outer shape.

13. The shaft according to claim 12, wherein
an inner peripheral surface of the diameter reduction portion is formed by a concave surface that curves in a concave shape with respect to an extending direction of the hole.

14. The shaft according to claim 11, wherein
an inner peripheral surface of the diameter reduction portion is formed by a concave surface that curves in a concave shape with respect to an extending direction of the hole.

15. The shaft according to claim 6, wherein
the outer hole portion extends radially inward from the open end for a prescribed length, while being perpendicular to an axis of the shaft and maintaining the outer shape.

16. The shaft according to claim 10 wherein an inner peripheral surface of the diameter reduction portion is formed by a concave surface that curves in a concave shape with respect to an extending direction of the hole.

17. The shaft according to claim 6, wherein
an inner peripheral surface of the diameter reduction portion is formed by a concave surface that curves in a concave shape with respect to an extending direction of the hole.
